(19) United States
(12) Patent Application Publication
(10) Pub. No.: US 2013/0210466 A1
(43) Pub. Date: Aug. 15, 2013

(54) Circuit Switched Fallback Proxy

(71) Applicants: Åke Arvidsson, Solna (SE); Sven Gemski, Solna (SE)

(72) Inventors: Åke Arvidsson, Solna (SE); Sven Gemski, Solna (SE)

(21) Appl. No.: 13/704,393

(22) PCT Filed: Nov. 9, 2012
(86) PCT No.: PCT/EP12/72312

§ 371 Date: Dec. 14, 2012

Related U.S. Application Data
(60) Provisional application No. 61/576,608, filed on Dec. 16, 2011.

(51) Int. Cl. H04W 68/00

(52) U.S. Cl. CPC H04W 68/005
USPC 455/458

(57) ABSTRACT

The present invention relates to proxy handling messages of a mobile user entity in a mobile communications network comprising a first switching control node supporting Circuit Switched Fallback (CSFB) functionality and a second switching control node not supporting the CSFB functionality. The proxy comprises an interface configured to receive a message containing Circuit Switched Fallback Mobile Originated (CSMO) call indicator or a Circuit Switched Fallback Mobile Terminated (CSMT) call indicator from the mobile user entity. A proxy control unit is configured: to determine whether the CSMO call indicator or the CSMT call indicator is set in the received message, initiate routing of the received message to the first switching control node if the CSMO call indicator or the CSMT call indicator is set, and initiate routing of the received message to the second switching control node if neither the CSMO call indicator nor the CSMT call indicator is set.

### TECHNICAL FIELD

The invention relates to a proxy handling messages of a mobile user entity in a mobile communications network, the mobile communications network comprising a first switching control node supporting a Circuit Switched Fallback (CSFB) functionality and a second switching control node not supporting the Circuit Switched Fallback (CSFB) functionality and to a method for handling messages of the mobile user entity by the proxy. The invention furthermore relates to a proxy handling paging messages for the mobile user entity and to a method for handling the paging messages by the proxy. The invention furthermore relates to a proxy handling routing of requests from the mobile user entity and to a method for handling the routing of the requests. The invention furthermore relates to a proxy routing call related messages for the mobile user entity in the mobile communications network to one of a plurality of switching control nodes and to a method therefor. Additionally, the invention relates to a proxy handling call related messages for the mobile user entity and to a method therefor. Additionally, the invention relates to a first switching control node supporting the Circuit Switched Fallback (CSFB) functionality.

### BACKGROUND

The new LTE (Long Term Evolution) radio access and VoLTE services such as Circuit Switched Fallback (CSFB), Single Radio Voice Call Continuity (SRVCC) and IMS Centralized Services (ICS) put new requirements on the existing MSC networks.

In order to support CSFB from the LTE access to the legacy GSM and WCDMA accesses, the legacy MSC layer must be upgraded with a new software (SW) version and in some cases also with new hardware (HW). The same SW and HW upgrade requirements on the MSC network are also applicable for the SRVCC handover and ICS features for VoLTE. In some cases such upgrades would mean that the whole MSC network has to be swapped for a newer HW generation. Several operators that are now planning for an introduction of the CSFB, SRVCC and ICS features state that they do not have the required budget for upgrading their legacy MSC network.

In one case an upgrade of the network is the best way forward for the customer. The reason for this is that the number of nodes, and thereby the cost for operation, is drastically reduced with the newer HW generations hence an upgrade means a reduced cost of the operation of the network.

In the other case two different overlaid solutions are possible which means that the legacy MSC network does not need to be upgraded. However, these overlaid solutions have some drawbacks which make it difficult to get acceptance from the operator community.

The problems with implementing support for the mentioned features in the legacy MSC network can be grouped into two different categories. The first major problem is the unacceptable cost for the upgrade. In FIG. 1 a situation is shown where the MSC node is replaced by a new MSC node 15 supporting the LTE related features, such as CSFB. In FIG. 1 a mobile user entity which is also supporting LTE related features, referenced with reference numeral 10 in FIG. 1, normally uses the LTE access network 11 which is directly coupled to the node MME 16 (Mobility Management Entity). Another mobile entity 13 not supporting LTE related features uses the GSM/WCDMA radio access network 12 and accesses the MSC 15 via BSC/RNC 14. When the LTE network is not available anymore, the mobile entity that was formerly connected to the LTE access network 11 falls back to the GSM/WCDMA access network 12 as shown by the arrow in FIG. 1. In this embodiment the MSC 15 would have to support the new LTE related features so that the mobile entity 10 could access the MME 16 via the MSC supporting the LTE related features which is also called CSFB MSC hereinafter.

The problems belonging to the second category can be seen in the fact that other solutions have a negative feedback on the performance of the network nodes. In FIG. 2 such an overlaid solution is shown. In the embodiment of FIG. 2 the same elements carry the same reference numerals and are not explained in detail anymore. In the overlaid solution shown an intermediate node, a CSFB gateway 17, handles the new features on behalf of the legacy nodes. This, however, implies extra signaling between the overlaid layer and legacy layer. This extra signaling implies a significantly prolonged call setup time and also an increased call drop rate. In the embodiment of FIG. 2 the MSC 18 is a legacy MSC and compared to the embodiment of FIG. 1 does not support the LTE features. The performance impact of a system shown in FIG. 2 due to the extra signaling is normally not acceptable for the operators of the mobile communications network.

The extra signalling also implies an extra processing load in the legacy layer. This may be acceptable while the number of users of the new services is relatively small compared to the number of legacy users. However, as the usage of the new services grows, the additional capacity requirement on the legacy network may cause overload and require additional nodes and signalling links etc. Hence overlaid solutions may not scale according to the requirements from the operators.

A first option to overcome the above-mentioned problem is to use the standard features of Multiple Operator Core Networks (MOON) or MSC pool which by definition can steer specific subscribers to specific MSCs based on IMSI (International Mobile Subscriber Identity) series or specific TMSI-NRIs (Temporary Mobile Subscriber Identity/Network Resource Identifier). With this capability it is possible to implement one or a limited number of new nodes for the new LTE related services only. The legacy network can then remain untouched.

A problem with these solutions is that they both assume that the respective features are available in the legacy RAN and legacy MSCs. In many older networks these features are not available and hence they cannot be used for the purpose of implementing LTE related features in new nodes.

The above-described embodiment is shown in FIG. 3. In the embodiment shown a legacy MSC 18 is provided that is responsible for the call controls of the legacy mobile user entities, whereas the CSFB MSC 15 is provided to control the call for the CSFB mobile user entity 10. The BSC/RNC 14 forwards call related messages depending on the IMSI or TMSI-NRI.

In FIG. 4 a second option is shown where a pool proxy 19 is included. In this version of the MSC pool the need for pool support in the RAN nodes is eliminated. However, this does not solve the problem with subscriber distribution between CSFB MSCs and the legacy MSCs, since pool functionality is also needed in the legacy MSCs. More specifically, the legally MSCs need to provide its subscribers with the so-called TMSI-NRIs that uniquely identifies the MCS for routing of signaling messages in the MSC Pool Proxy.

In more detail, an MSC which supports pool always generates TMSIs with a (set of) unique TMSI-NRI(s) so that all signaling messages from the RAN and pool proxy are routed to the correct MSC in the pool. The TMSI-NRI is a dedicated field within the TMSI which has a unique (set of) value(s) for each MSC in the pool. An MSC which does not support pool generates TMSIs completely independently of the TMSI-NRI field. It may thus be that the legacy MSCs must be updated or patched to support TMSI allocation from specific NRI ranges.

In FIG. 5 the TMSI format and the location of the NRI is shown.

If no such modifications are made to the legacy MSCs, there will occasionally be clashes in the TMSI addressing such that subscribers of the legacy MSC will be routed to the CSFB MSC. This is because TMSIs generated in the legacy MSC will accidentally include the TMSI-NRI of the CSFB MSC hence the MSC pool proxy will route those subscribers to the CSFB MSC.

As shown in FIG. 5, the TMSI-NRI is a ten bit number. The theoretical probability for these clashes, assuming a maximum TMSI-NRI length of 10 bits and only looking at the number of TMSI-NRIs versus TMSIs, is 1/210=1/1024, i.e. one out of every 1024 subscribers at the legacy MSC would be incorrectly routed to the CSFB MSC. The only way of reducing this probability is to let the MSC Pool Proxy base its decisions on more bits but the NRI field.

A further aspect of this problem is that the TMSI assignment typically is not done at random but more likely according to a certain procedure such as selecting the next higher available number. This means that clashes can occur for all new TMSIs during longer periods of time. Long periods with TMSI-clashed would not be acceptable since it would mean that all new legacy subscribers (normal CS subscribers), for this period, would be routed to the CSFB MSC only. The result would be an uncontrolled and unpredictable load in the network.

Accordingly, a need exists to solve the above-mentioned routing problem without modifying the legacy MSC while minimizing or even avoiding the above-discussed TMSI-NRI clashes.

### SUMMARY

This need is met by the features of the independent claims. Additional features are described in the dependent claims.

According to a first aspect, a proxy handling messages of a mobile user entity in a mobile communications network is provided, the mobile communications network comprising a first switching control node supporting a CSFB functionality and a second switching control node not supporting the CSFB functionality. The proxy comprises an interface configured to receive a message containing a Circuit Switched Fallback Mobile Originated (CSMO) call indicator, or a Circuit Switched Fallback Mobile Terminated call (CSMT) indicator from the mobile user entity. The proxy furthermore comprises a control unit configured to determine whether the Circuit Switched Fallback Mobile Originated (CSMO) call indicator or the Circuit Switched Fallback Mobile Terminated call (CSMT) indicator is set or present in the received message. If the CSMO indicator or the CSMT indicator is set, the control unit is configured to initiate the routing of the received message to the first switching control node which supports the CSFB functionality. If neither the CSMO indicator nor the CSMT indicator is set, the control unit is configured to initiate a routing of the received message to the second switching control node. This circuit switched fallback proxy solution enables a new CSFB capable MSC to serve a common GSM or WCDMA network in parallel with an existing non-CSFB capable MSC, here the second switching control node mentioned above, the CSFB capable MSC being the first switching control node mentioned above.

The proxy or circuit switched (CS) fallback proxy named hereinafter steers circuit switched fallback subscribers and related traffic to a CS fallback capable MSC and legacy subscribers and related traffic to a legacy MSC. The proxy uses the CSMO indicator or CSMT indicator to decide whether the messages are routed to the first or to the second switching control node. In the invention the CSMO indicator or CSMT indicator are used as input for routing. The message can be a location update message, such as a location update request message, or a location update response message, a connection management request message or a paging response message.

The invention furthermore relates to a method for handling the call related messages by the proxy in the network comprising the two switching control nodes mentioned above. According to one step of the method a message is received from the mobile user entity containing the CSMO indicator or CSMT indicator. In an additional step it is then determined whether the CSMO indicator or CSMT indicator is set in the received message. If the CSMO indicator or the CSMT indicator is set, the received message is routed to the first switching control node and if neither the CSMO indicator nor the CSMT indicator is set, the message is routed to the second switching control node. In the present context it means that the CSMO or CSMT indicator is not present in the message as messages from a legacy user equipment do not contain the indicator at all.

The invention furthermore relates to a proxy handling paging messages for a mobile user entity in a mobile communications network, the mobile communications network comprising the first switching control node supporting the CSFB functionality and the second switching control node not supporting the CSFB functionality. The proxy comprises an interface configured to receive a paging response from the mobile user entity. Furthermore, the proxy comprises a control unit configured to identify a mobile subscriber identity information and an originating signaling point information in the paging response. Furthermore, the control unit is configured to initiate a further routing of the received paging response. The proxy furthermore contains a database containing, for different mobile user entities, mobile subscriber identify information related to originating signaling point information. The control unit is configured to search for mobile subscriber identity information in the database that matches the mobile subscriber identity information contained in the paging response. When a matching mobile subscriber identity information is found in the database, the control unit is configured to initiate a further routing of the paging response to the second switching control node and when no matching mobile subscriber identity information is found in the database, the control unit is configured to initiate a routing of the paging response to the first switching control node. When no matching subscriber identity information is found in the database of the proxy, the paging request was sent from the first switching control node over an SGs interface and LTE so that no matching originating signaling point information can be found in the proxy. If a matching mobile subscriber identity information can be found, the paging request was sent from the second switching control node, so that the paging response will also be further transmitted to the second switching control node.

It is possible that the interface is further configured to receive a paging request from said mobile user entity from the second switching control node. The control unit of the proxy may then identify the mobile subscriber identity information and the related originating signaling point information in the paging request and store it in the database together with its originating signaling point information.

In this embodiment the proxy contains mobile subscriber identity information and related originating signaling point information from all requests sent from the second switching control node. When a paging response is received from the mobile user entity and if the paging response does not contain the Circuit Switched Fallback Mobile Terminated (CSMT) call indicator, the proxy can determine that the paging response should be forwarded to the second switching control node, e.g. the legacy MSC.

The invention furthermore relates to a method for handling paging messages by the proxy as mentioned above.

The invention furthermore relates to a proxy handling routing of requests from a mobile user entity in the mobile communications network, the network comprising the first switching control node supporting CSFB functionality and the second switching control node not supporting the CSFB functionality. The proxy comprises an interface configured to receive a location update request message from the mobile user entity including a Temporary Mobile Subscriber Identity Network Resource Identifier (TMSI-NRI) number. Furthermore, a control unit and a database are provided, the database containing a first range of Temporary Mobile Subscriber Identity Network Resource Identifier (TMSI-NRI) numbers and a second range of TMSI-NRI numbers different from the numbers in the first range. When the interface receives a location update request message from the mobile user entity including a TMSI-NRI, the control unit is configured to identify the included TMSI-NRI and to initiate a routing of the location update request message to the first switching control node when the TMSI-NRI is within the first range. Furthermore, the control unit initiates a routing to the second switching control node when the TMSI is within the second range.

In this embodiment the MOON routing mechanism is used for the purpose of avoiding and handling TMSI conflicts between the first switching control node and the second switching control node when connected to a common proxy. In this embodiment as in the CSMO-CSMT indicator embodiment the association of originating signaling point codes with paging requests and paging responses may be used in order to assure that mobile terminated calls from the second switching control node are always successful regardless if the TMSI occasionally happens to includes bits that are matching the TMSI-NRI of the first switching control node.

In this embodiment it is possible that when the interface receives a location update reject message from the first switching control node, the control unit may, when receiving the location update reject message from the first switching control node, initiate a routing of a new location update request message to the second switching control node. In this embodiment, when the second switching control node not supporting the CSFB functionality and which is not aware that a certain range of TMSI-NRI is reserved for the first switching control node accidentally allocates a TMSI in a range reserved for the first switching control node, the consecutive location update request message will wrongly be routed to the first switching control node. The first switching control node will then analyze the IMSI of this subscriber and will detect that it is not registered over the SGs interface as for the other CSFB subscribers. The IMSI is not valid for roaming in the first switching control node. As a result, the first switching control node will redirect the subscriber to the proxy which then in turn sends the new location update request message to the second switching control node.

Furthermore, it is possible that the interface is further configured to receive a paging request for said mobile user entity from the second switching control node. The control unit of the proxy may then be configured to identify a mobile subscriber identity information and an originating signaling point information in the paging request and may be configured to store the mobile subscriber identity information with its originating signaling point information from the paging request in the database.

In this embodiment the interface may be further configured to receive a paging response from the mobile user entity. The control unit is then configured to identify the mobile subscriber identity information and an originating signaling point information in the paging response and initiates a further routing of the received paging response. The control unit then searches for the mobile subscriber identity information in the database that matches the mobile subscriber identity information contained in the paging response. When a matching mobile subscriber identity information is found in the database, the control unit can then be configured to initiate a further routing of the paging response to the second switching control node. However, when no matching mobile subscriber identity information is found in the database, the control unit initiates a routing of the paging response to the first switching control node.

The invention furthermore relates to a method for handling routing of requests by the proxy to the steps carried out by the proxy handling routing of requests as mentioned above.

The invention furthermore relates to a proxy routing call related messages for a mobile user entity in a mobile communications network to one of a plurality of switching control nodes, the mobile communications network comprising the first switching control node supporting the CSFB functionality and a second switching control node not supporting the CSFB functionality. The proxy comprises a receiver configured to receive a call related message including a Temporary Mobile Subscriber Identity Number (TMSI). Furthermore, a control unit is provided configured to identify the included Temporary Mobile Subscriber Identity number TMSI and to convert the Temporary Mobile Subscriber Identity number TMSI into a converted Temporary Mobile Subscriber Identity number TMSI' of a converted space in such a way that the converted TMSI' is randomly distributed in the converted space. The proxy furthermore contains a database containing a first range of converted TMSI' reserved for the first switching control node and a second range of converted TMSI' different from the numbers in the first range in the converted space. The control unit is configured to initiate a routing of the call related messages to either the first or the second switching control node based on the converted temporary mobile subscriber identity number TMSI'. The control unit is configured to route the call related message to the first switching control node when the converted temporary mobile subscriber identity number TMSI' is within the first range and is configured to route the call related message to the second switching control node when the converted temporary mobile subscriber identity number TMSI' is within the second range.

In this embodiment the TMSI' range is subdivided into two ranges, one range for the first switching control node and a second range for the second switching control node. This embodiment avoids the problem that, as TMSI assignment is typically not done at random but more likely according to a procedure where the next higher available number is used, clashes appear over a longer period of time.

In order to avoid that TMSI clashes will occur in an aggregated form over a longer period of time when the second switching control node assigns TMSIs of the range reserved for the switching control node, the TMSIs are converted into the converted space where the TMSI's are randomly distributed. So when the control node initiates a routing to either the first or second switching control node based on the TMSI', TMSI clashes will be occurring in a less aggregated form and more randomly, i.e. not over a longer period of time continuously.

In this embodiment the interface of the proxy may receive a call related message from the second switching control node. The control unit can then be configured to identify after conversion, the converted Temporary Mobile Subscriber Identity number TMSI' in the converted space in the message and if the converted TMSI' number is within the first range reserved for the first switching control node, the control unit replaces the TMSI by a predefined TMSI number. Numbers are reserved in both spaces since it relates to the same set of TMSI values. The point is that these reserved numbers, in the transformed space, form a compact subset (all numbers between a first member and a last member) called the “reserved range” while, in the original space, they are “randomly” scattered throughout the entire range of possible TMSI values. So it is easier and faster to do the transformation first and then check whether the result is in this closed subset, but it would be possible not to do the transformation but to compare the original number against a list of all reserved numbers, a list of all the numbers that, after transformation, would fall within the compact subset called the “reserved range”. In another embodiment, as an alternative, if the temporary mobile subscriber identity number received in a call related message from the second switching control node is within the first range reserved for the first switching control node, the control unit may discard the message.

Preferably, the control unit can be configured in such a way that the temporary mobile subscriber identity number TMSI is converted into a converted TMSI' by using a formula by which each TMSI is converted into exactly one value of a converted TMSI'. Furthermore it is possible that the control unit converts the TMSI into a converted TMSI' by using a formula by which consecutive numbers of TMSIs are transformed into randomly scattered converted TMSI's.

The invention furthermore relates to a corresponding method for routing request messages by the proxy.

The invention furthermore relates to a proxy handling call related messages for a mobile user entity in the mobile communications network, the network comprising the first switching control node and the second switching control node. The proxy furthermore contains a database containing a first set of temporary mobile subscriber identity numbers TMSI to be used for a communication between the proxy and the second switching control nodes of the mobile communications network and a second set of temporary mobile subscriber identity numbers TMSI to be used for a communication between the proxy and the mobile user entity, wherein a predefined range of the temporary mobile subscriber identity numbers TMSI of the first set is contained in a reserved range of TMSIs reserved for the first switching control node. The database furthermore contains a translation table containing an entry for each of the mobile user entities, the respective calls of which are handled by the second switching control node. The translation table translates a TMSI of the first set contained in the reserved range to a TMSI of the second set and vice versa. Furthermore, an interface is provided configured to receive call-related messages including a temporary mobile subscriber identity number, the TMSI from the second switching control node. A control unit is provided configured to identify the TMSI included in the call-related message transmitted from the second switching control node. When an identified TMSI in the call-related message from the second switching control node is within the reserved range of the first set, the control unit is configured to translate the identified TMSI in the received message by a TMSI of the second set based on the translation table, wherein the control unit is configured to leave the identified TMSI untranslated when the TMSI is not within the reserved range.

In this embodiment TMSI clashes are avoided by using a first set of TMSIs between the second switching control node and the proxy and another set between the proxy and the mobile user entity. The second switching control node may assign any TMSI, while the proxy only assigns TMSIs in the unreserved range, i.e. in the range not reserved for the first switching control node.

In this embodiment it is possible that the control unit can be configured to replace the identified TMSI by a TMSI of the second set for TMSIs received on an A interface of the proxy and received on an E interface of the proxy.

The second switching control nodes mentioned above in the different embodiments may be a legacy mobile switching center supporting a GSM or WCDMA mobile communications network, whereas the first switching control node may be a MSC supporting CSFB functionality.

The invention furthermore relates to the corresponding method.

According to a further aspect of the invention a proxy handling call related messages for a mobile user entity is provided in a mobile communications network, the mobile communications network comprising the first switching control node supporting the CSFB functionality and a second switching control node not supporting the CSFB functionality. The proxy comprises a monitoring unit configured to monitor a signaling traffic of the second switching control node and configured to generate a list of temporary mobile subscriber identity numbers TMSI used by the second switching control node. The proxy furthermore contains an interface configured to inform the first switching control node of the generated list.

In this embodiment the first switching control node is informed of the TMSIs used by the second switching control node so that the first switching control node can avoid assigning TMSIs used by the second switching control node.

The invention furthermore relates to a first switching control node supporting the CSFB functionality in the mobile communications network, the mobile communications network further comprising the second switching control node not supporting the CSFB functionality. The first switching control node comprises an interface configured to receive a list of TMSIs used by the second switching control node, the list being received from the proxy handling the call related messages. A control unit is provided configured to generate TMSIs for messages controlled by the first switching control node. The control unit is configured to generate the TMSI numbers in such a way that is does not generate TMSIs contained in the list or by changing its assigned TMSIs used by the first switching control unit and contained in the received list in such a way that its assigned TMSIs also contained in the list are replaced by a TMSI not contained in the list.

In this context it is possible that the control unit assigns TMSIs that have been recently released by the second switching control node.

### BRIEF DESCRIPTION OF THE DRAWINGS

A more complete understanding of the present invention and the advantages thereof may be acquired by referring to the following description in consideration of the accompanying drawings, in which like references numbers indicate like features, and wherein

FIG. 1 shows a situation how a circuit switched fallback support and legacy network would look like,

FIG. 2 shows the situation of a circuit switched fallback with an overlaid circuit switched fallback gateway,

FIG. 3 shows the situation of a circuit switched fallback with an MOON or MSC pool in a legacy network,

FIG. 4 shows the situation of a circuit switched fallback with an MSC pool proxy,

FIG. 5 shows the TMSI format and the location of the NRI,

FIG. 6 shows the situation of a circuit switched fallback with a media gateway based CSFB proxy according to the invention,

FIG. 7 shows the situation of a circuit switched fallback with a RAN node based CSFB proxy according to the invention,

FIG. 8 shows a handling of a mobile originated call from legacy users according to one aspect of the invention,

FIG. 9 shows the handling of a mobile originated call from CSFB users according to another aspect of the invention,

FIG. 10 shows the handling of a mobile terminated call and paging responses for legacy users according to another aspect of the invention,

FIG. 11 shows the handling of mobile terminated calls and paging responses for CSFB mobile terminated calls according to another aspect of the invention,

FIG. 12 shows a handling of mobile terminated calls and paging response for legacy users according to another aspect of the invention,

FIG. 13 shows a handling of mobile terminated calls and paging response for CSFB users according to another aspect of the invention,

FIG. 14 shows the handling of location updates from legacy users according to another aspect of the invention,

FIG. 15 shows the handling of location updates from CSFB users according to another aspect of the invention,

FIG. 16 shows the handling of location updates from CSFB users when changing location area, LA, due to CSFB.

FIG. 17 shows the handling of conflicting TMSIs with MOCN based CSFB proxy,

FIG. 18 shows a schematic view of a proxy handling messages according to one aspect of the invention,

FIG. 19 shows another proxy handling messages according to another aspect of the invention, and

FIG. 20 shows a first switching control node supporting CSFB functionality according to one aspect of the invention.

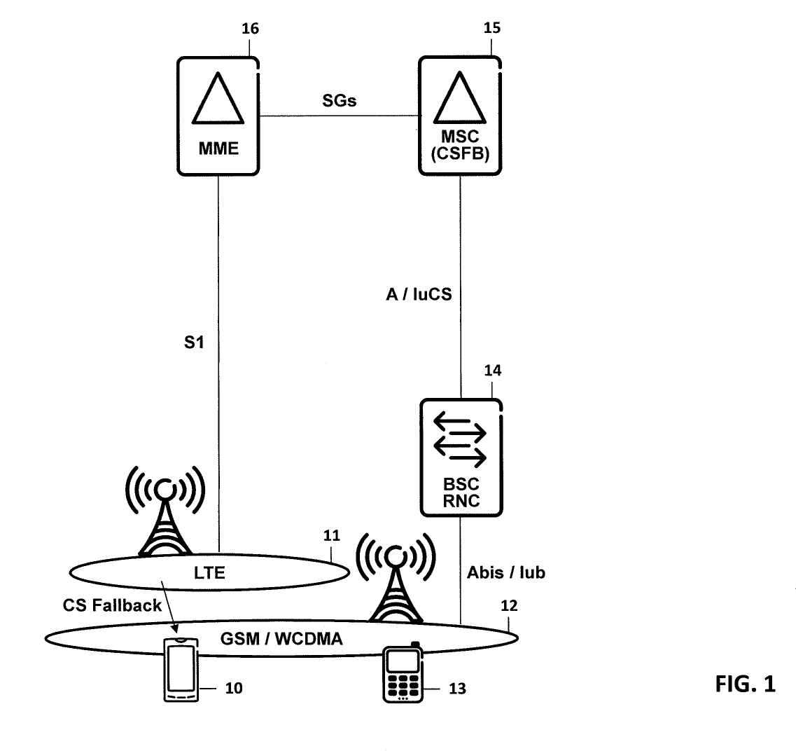

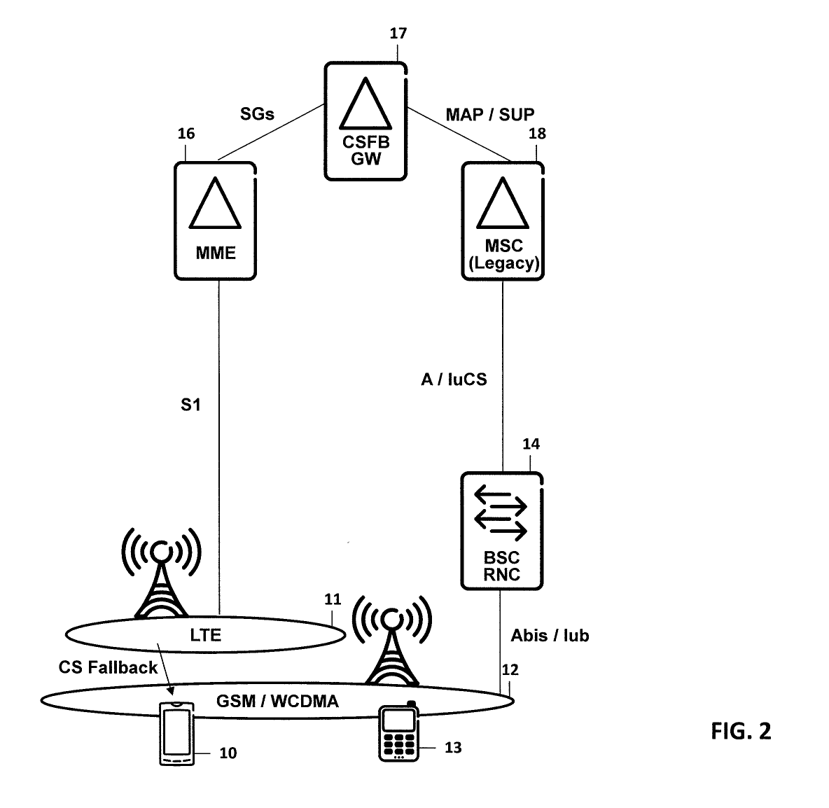

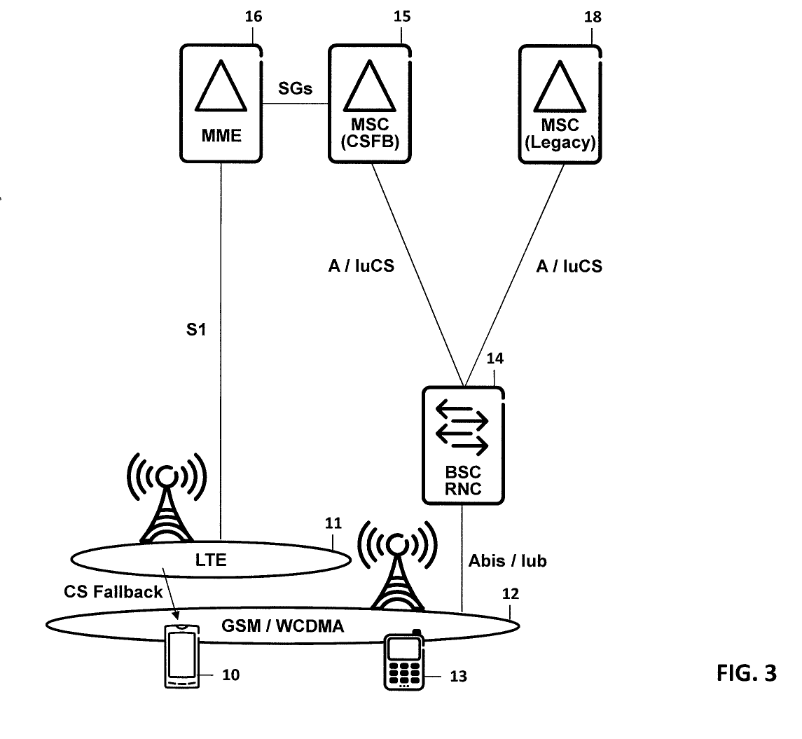

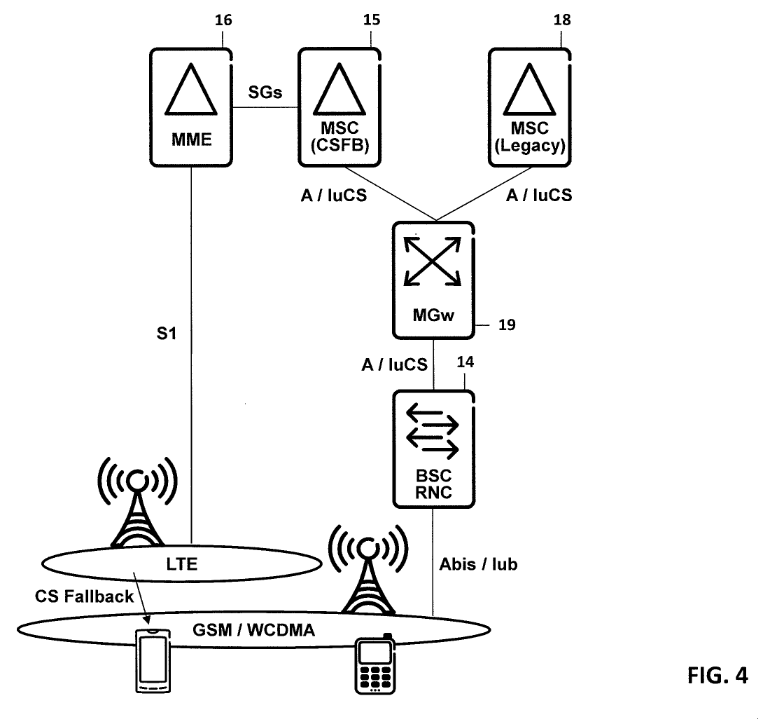

### DETAILED DESCRIPTION

The invention provides a solution to routing problems in mobile communications networks with a first switching control node supporting the CSFB functionality and with a second switching control node not supporting the CSFB functionality. The invention especially provides a solution where the second switching control node already present in the networks needs not to be modified. The invention inter alia provides a circuit switched fallback proxy solution that enables the first switching control node, e.g. a CSFB capable MSC, to serve a common GSM or WCDMA network in parallel with an existing second switching control node, e.g. the non-CSFB capable MSC, also called legacy MSC hereinafter without modifying the latter.

One or more aspects of the invention may be embodied in computer executable instructions, such as in one or more program modules, executed by one or more computers or other devices. Generally, program modules include routines, programs, objects, components, data structures etc. that perform particular tasks or implement particular abstract data types when executed by a processor or a plurality of processors in a computer or other device. The computer executable instructions may be stored on a computer readable medium, such as a hard disk, an optical disk, removable storage media, solid state memory, ROM, etc. As will be appreciated by a person skilled in the art, the functionality of the program modules may be combined or distributed as desired. In addition, the functionality may be embodied in whole or in part in firmware or hardware equivalents, such as integrated circuits, field programmable gate arrays (FPGA), and the like. Furthermore, the modules may be incorporated by a combination of hardware and software.

The circuit switched fallback proxy steers circuit switched fallback subscribers and related traffic to a circuit switched fallback capable MSC and legacy subscribers and related traffic to a legacy MSC.

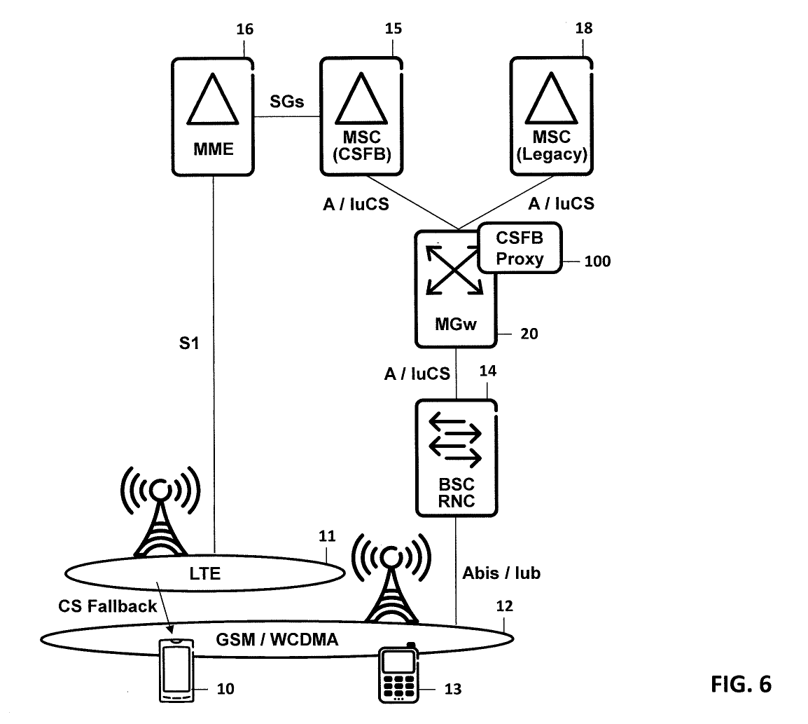

Such a situation is shown in FIG. 6 where the fallback proxy or CSFB proxy 100 is incorporated into a media gateway 20.

In the embodiment shown the CS fallback proxy is incorporated into a media gateway. However, the CS fallback proxy is a logical function that can be implemented in either the media gateway and an MSC or the radio access network node (BSC and RNC) and the MSC. The CS fallback proxy assumes partly support of the A/lu-flex standard (pooling), where multiple core network nodes can be connected to a common radio access network node. No new functionality is needed in the existing legacy MSCs.

In the embodiment described below the separation of CSFB and legacy subscribers and related traffic is done with no or with a minimum and predictable risk for clashes in the TMSI generation in the respective MSCs. Further on, the solution does not add any significant delay in the call setup time and it does not add any significant signaling load on the legacy network.

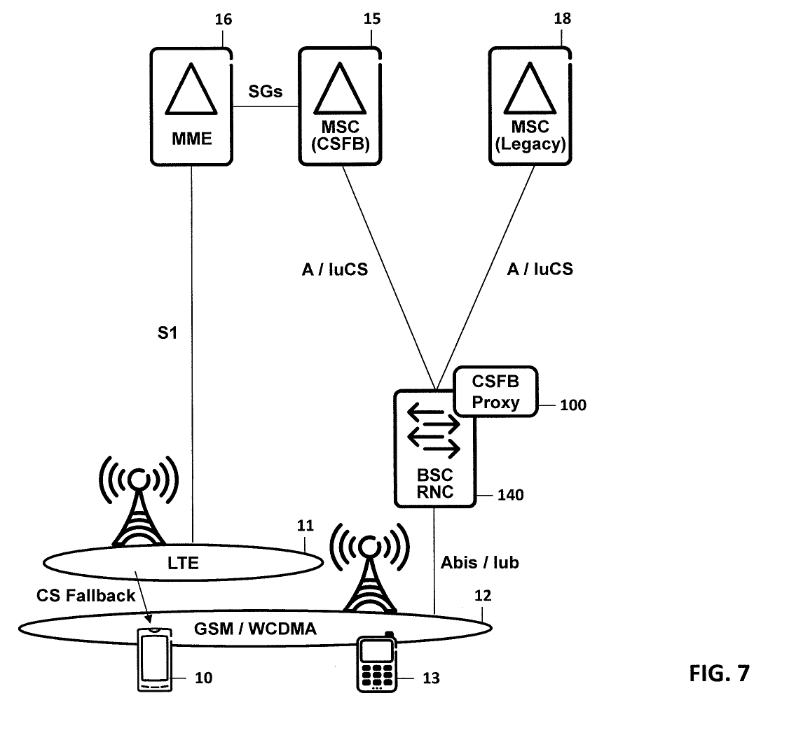

In the embodiment of FIG. 7 the CSFB proxy 100 is incorporated into the radio access network symbolized by BSC RNC 140 of FIG. 7.

In the following different embodiments are described how the traffic of a circuit switched fallback subscriber is directed to the CSFB MSC or first switching control node and how traffic of a legacy subscriber is forwarded to a legacy MSC or second call control node.

### CSMT and CSMO Flag Routing

### Standard

3GPP Release 10 introduces the new concept of CSMT- and CSMO flag as additional parameters (3GPP TS 24.008 Rel 10, chapter 10.5.3.14) in the location updating request message and the CM service request message.

This embodiment of the invention now uses the CSMT and CSMO flags or CSMT/CSMO indicator for an additional purpose compared to the intention of the standards. The flags are here used as input for routing of location update requests and CM service requests (mobile originated calls) in the CS fallback proxy.

Whenever a CM (Connection Management) service request or location update request is received in the CSFB proxy 100 it analyses the CSMT and CSMO flags. If the CSMT or CSMO flag is set (1), the messages are routed to the CSFB capable MSC 15. If the CSMT or CSMO flag is not set (0), they are routed to the legacy MSC 18.

Another feature of the CSFB proxy 100 is the association of originating signaling point code (OPC) with paging requests and paging responses. A paging request from the legacy MSC 18 is stored with the IMSI or TMSI together with the OPC of the legacy MSC 15. When the paging response from the radio network arrives in the CSFB proxy 100, it is routed to the legacy MSC 15 if it can be associated with a stored paging request. If not, the paging response must be for a CSFB call (paging request sent over SGs-interface), and it will then instead be sent to the CSFB capable MSC 18.

TMSI clashes between end users in the CSFB MSC and the legacy MSC are avoided with this solution since the subscribers and related traffic always are routed to the correct MSC. I.e. the TMSI ranges from the different MSCs can overlap between the MSCs without any conflicts. If a CSFB user 16 loses coverage with the LTE network 11, it will be considered as a legacy user and register with the legacy MSC. The (old) TMSI of this subscriber may then be already allocated to another legacy user. This clash will however be resolved during the location update procedure since the authentication procedure will fail and a new location update will be done together with a TMSI reallocation.

The invention solves the different mobile originated or mobile terminated and location update use cases which otherwise would lead to conflicts between the CSFB and legacy MSCs.

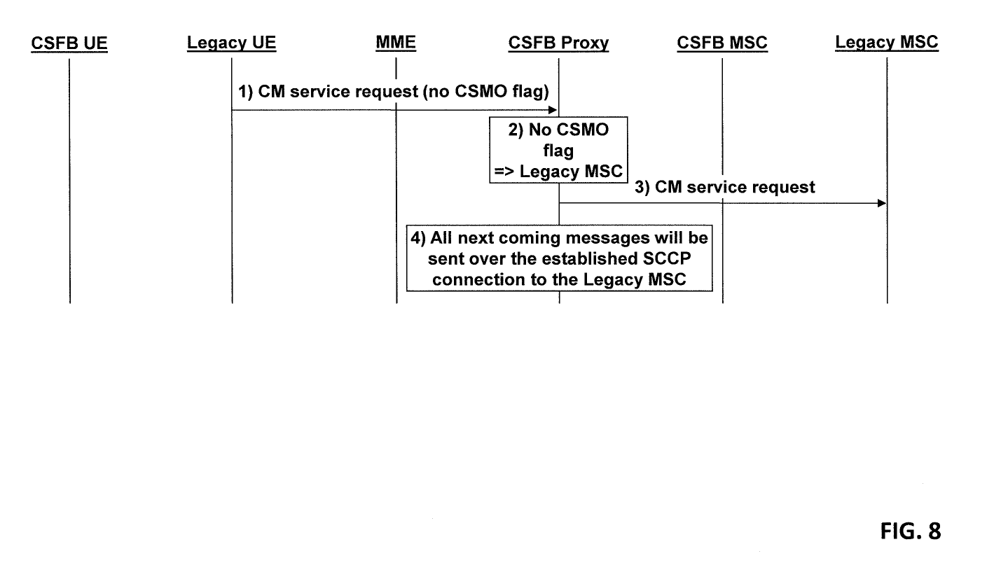

In FIG. 8 the handling of a mobile originated call from a legacy user is shown in more detail. In a first step a connection management (CM) service request is sent from the legacy user to the CSFB proxy 100. In the second step the CSFB proxy analyzes the CM service request from the legacy user and checks whether the CSMO flag is set. As the flag is not set, the message is routed to the legacy MSC in step 3. As shown in step 4, all next coming messages will be sent over the established SCCP (Signaling Connection Control Part) connection to the legacy MSC.

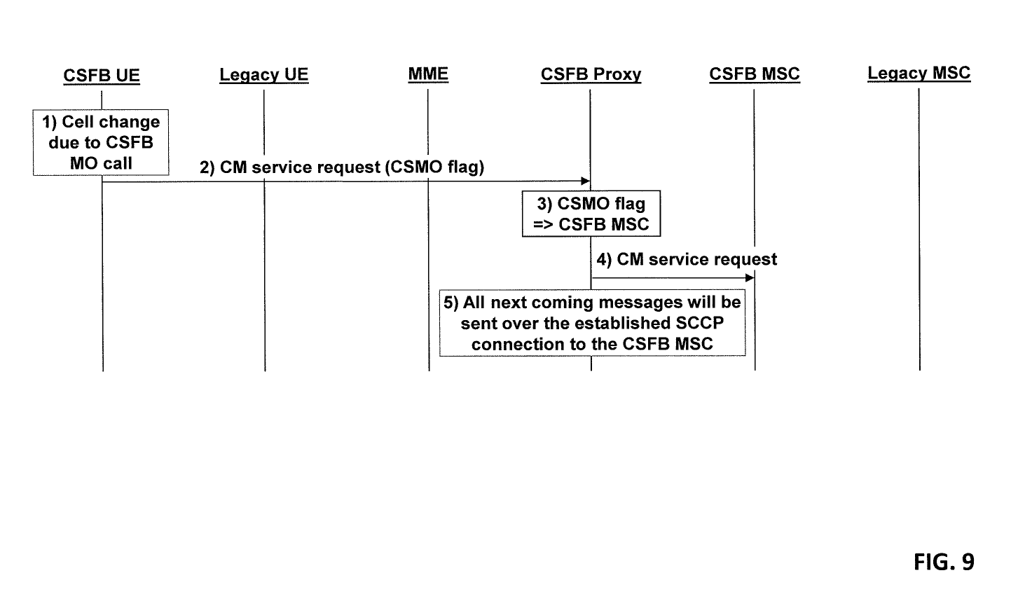

In FIG. 9 the situation is shown for a mobile originated call from a CSFB user. As shown in step 1, a cell change occurs due to a CSFB mobile originated call. In step 2 the CSFB mobile user entity, e.g. the mobile user entity 10 shown in FIGS. 6 and 7, sends the CM service request to the CSFB proxy with the CSMO flag being set. In step 3 the CSFB proxy then analyses the CM service request from the CSFB user. As the flag is set, the message is routed in step 4 to the CSFB MSC. As shown in step 5, all next coming messages will be sent over the established SCCP connection to the CSFB MSC.

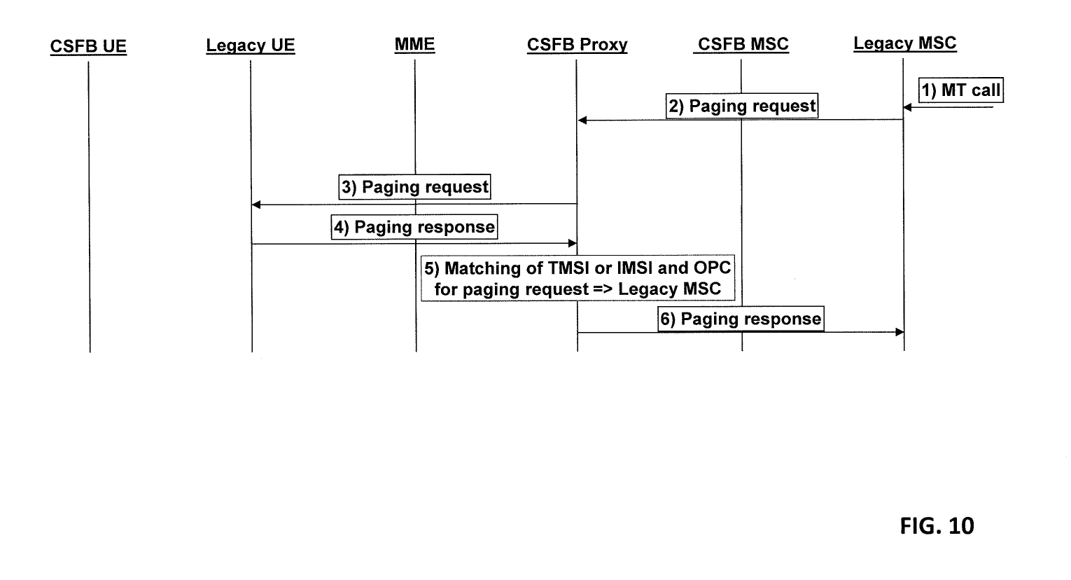

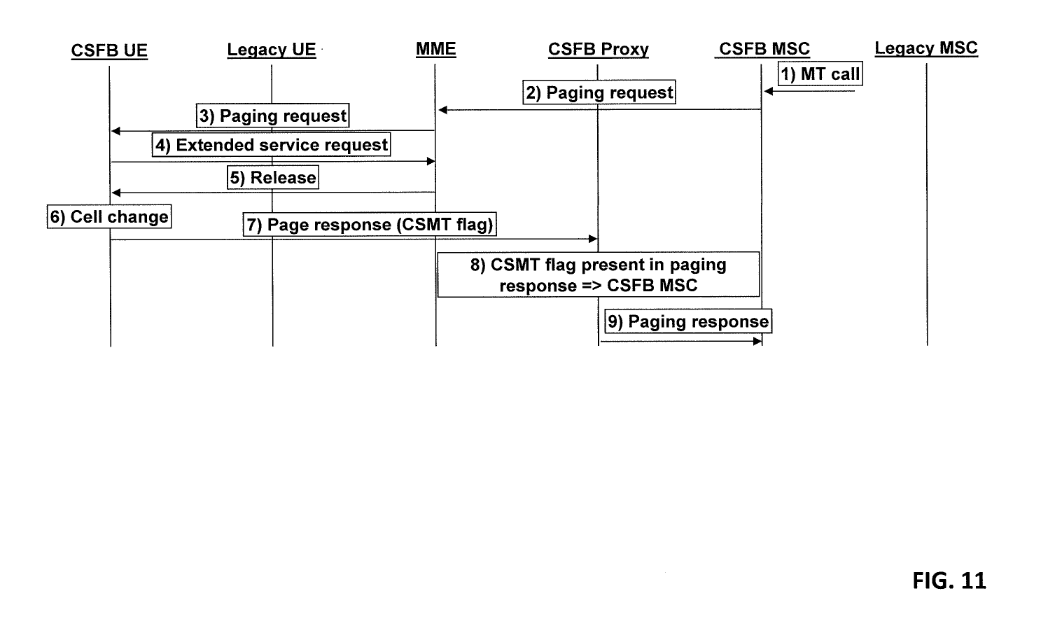

In connection with FIGS. 10 and 11 an embodiment is shown where the CSMT flags are also present in paging responses. In FIG. 10 as shown in step 1 the legacy MSC receives a mobile terminated call. In step 2 the legacy MSC then transmits a paging request to the CSFB proxy. The CSFB proxy then sends a paging request to the legacy UE which answers with the paging response. The CSFB proxy then analyses the paging response. As shown in step 5, as no CSMT flag is present in the paging response, the paging response is further forwarded to the legacy MSC as shown in step 6.

A corresponding situation for a CSFB user entity is shown in FIG. 11. In step 1 the mobile terminated call is received by the CSFB MSC. The paging request is then forwarded to the MME in step 2. The MME transmits a paging request to the CSFB UE, the latter answering in step 4 with an extended service request. In step 5 the MME informs the CSFB UE about the release. If now in step 6 a cell change occurs, a paging response with the CSMT flag being set is transmitted to the CSFB proxy. The CSFB proxy then analyzes the paging response and as the flag is present in the paging response, the CSFB proxy can follow that the paging response should be transmitted to the CSFB MSC and not to the legacy MSC as done in step 9.

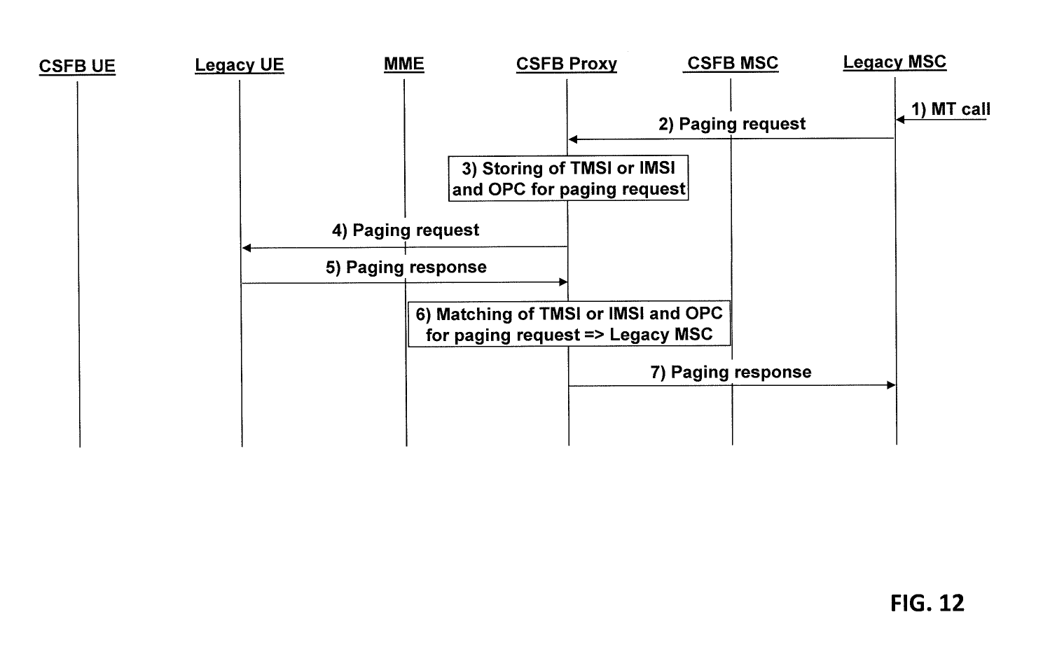

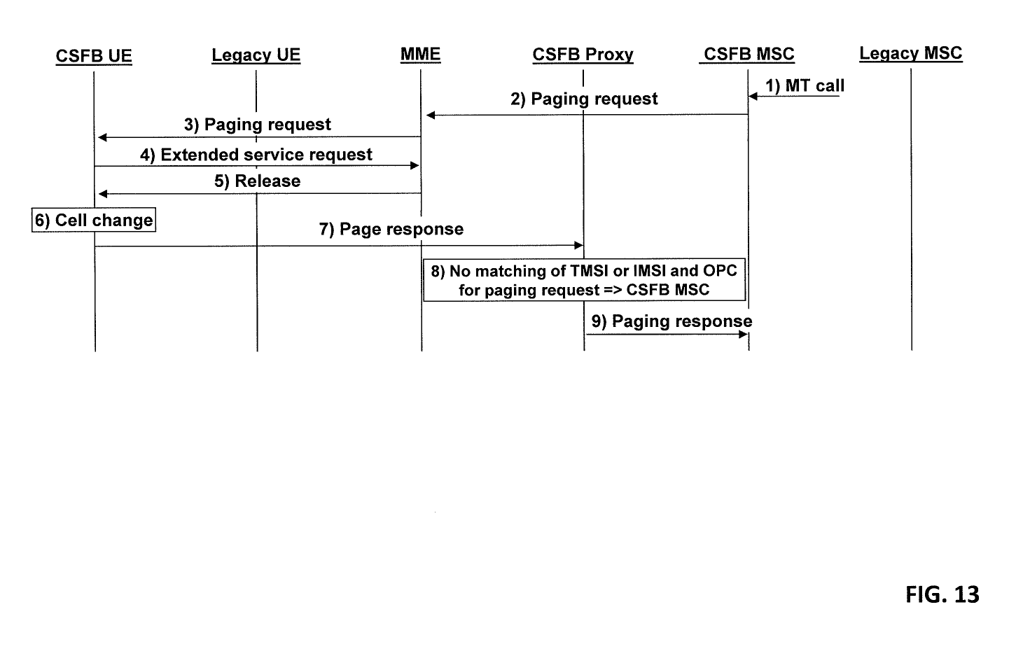

In connection with FIGS. 12 and 13 the handling of mobile terminated calls and paging responses for legacy users and CSFB users, respectively is explained in more detail. In FIG. 12 in step 1 the legacy MSC receives a mobile terminated call for a legacy user. In step 2 the paging request is sent to the CSFB proxy. The CSFB proxy then stores the TMSI or IMSI and the OPC (Originating Point Code). In step 4 the CSFB proxy transmits the paging request to the legacy UE which answers with a paging response in step 5. When the paging response is received in the CSFB proxy, the latter searches for a matching IMSI or TMSI in its database where the TMSI or IMSI with the OPC were stored. Since the paging request was sent from a legacy MSC, a matching IMSI or TMSI with the OPC will be found and the paging response will be further routed to the legacy MSC (steps 6 and 7).

In FIG. 13 the corresponding case for a CSFB user is shown. In step 1 the mobile terminated call is received by the CSFB MSC. The CSFB MSC then forwards a paging request to the MME (step 2). In step 3 the MME sends a paging request to the CSFB mobile user entity which sends back in step 4 the extended service request. In step 5 a release message is sent to the CSFB user entity. The user moves to “CSFB mode” which means it will use another radio technology, i.e. one that supports CS, for the duration of a call. In step 6 the cell change occurs, the CSFB UE transmitting a paging response to the CSFB proxy. In this example the terminating CSFB call is first visible to the CSFB proxy when the paging response in step 7 arrives. The CSFB proxy will search for a matching IMSI or TMSI in the store/database in step 8, but since the paging request was sent from the CSFB MSC over the SG interface and LTE of steps 2 and 3, no matching IMSI or TMSI with OPC will be found and the paging response will be routed to the CSFB MSC in step 9. In the embodiments shown in FIGS. 12 and 13, the paging response did not necessarily contain the CSMT or CSMO flag in step 7. This is why in step 8 of FIG. 13 the decision is based on the fact that no TMSI or IMSI is found in the database with a corresponding OPC. The CSFB proxy stores the TMSIs or IMSIs with the corresponding OPCs when receiving a paging request. Based on the presence of a TMSI or IMSI in the database that corresponds to a TMSI or IMSI of a paging response, a routing decision can be taken. In the embodiment of FIG. 11 the flag was also present in the paging response so that a routing decision can be taken by directly checking whether the flag is set or not. The query of the database as in FIGS. 12 and 13 is not necessary.

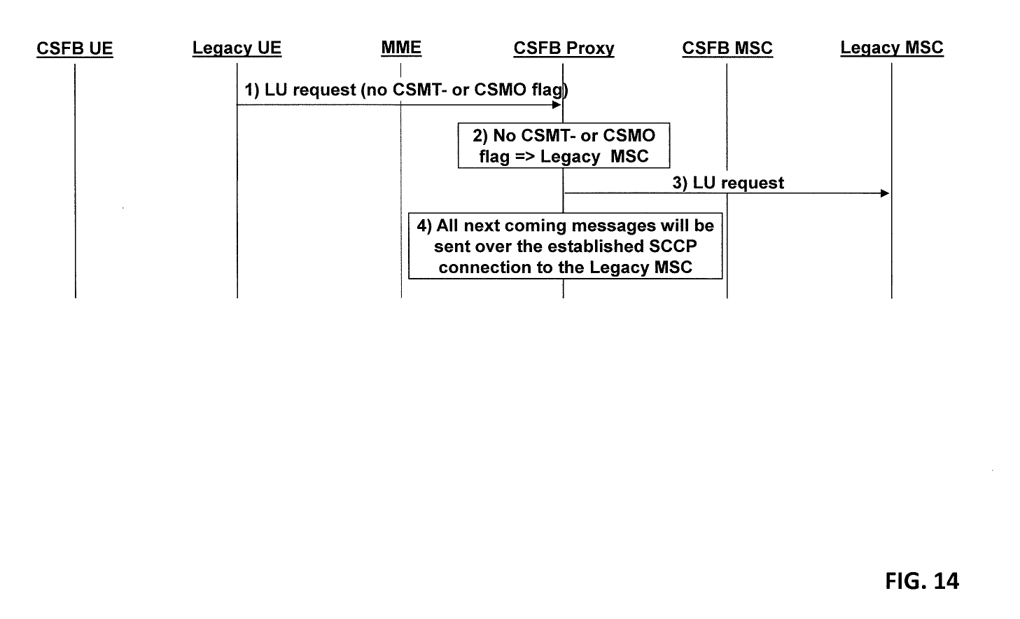

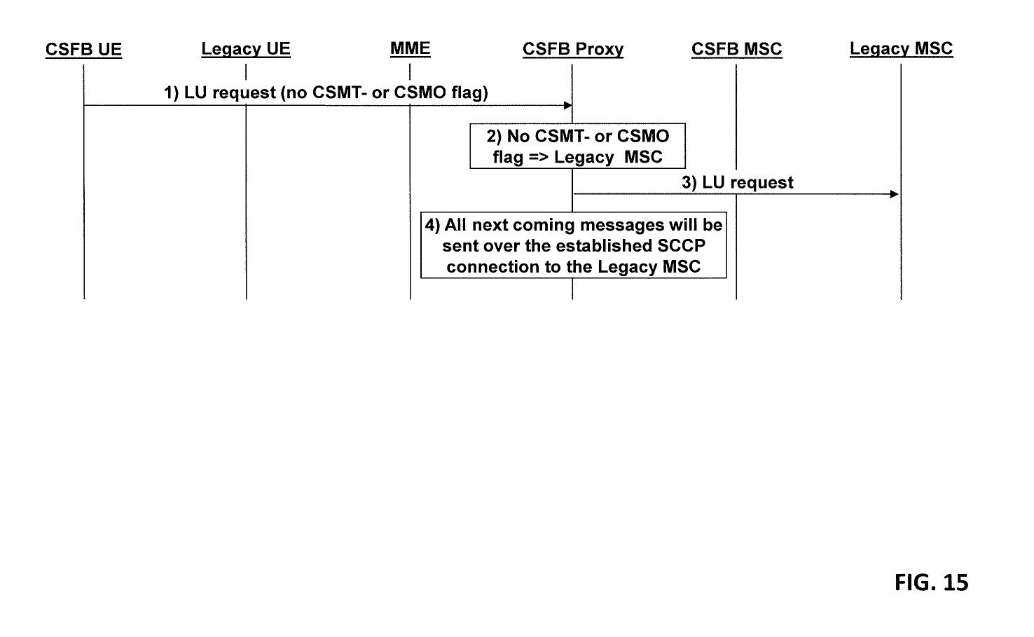

In connection with FIGS. 14 and 15 the handling of location updates from legacy users or CSFB users when losing LTE coverage is shown. In FIG. 14 in a first step the legacy UE transmits a location update request to the CSFB proxy. This request does not contain a CSMT or CSMO flag. In step 2 the CSFB proxy checks whether the CSMT or CSMO flag is set. As neither the CSMT nor the CSMO flag is set, the message is routed to the legacy MSC in step 3. In step 4 all next incoming messages will be sent over the established SCCP connection to the legacy MSC.

In FIG. 15 the location update of the CSFB user when losing LTE coverage is shown. The CSFB user entity transmits a location update request with the CSMT or CSMO flag being set. In step 2 the CSFB proxy analyses the location update request from the CSFB user. As neither the CSMT nor CSMO flag is set (since the location update is not triggered by a CSFB call), the message is routed to the legacy MCS in step 3. In step 4 all next coming messages will be sent over to the established SCCP connection to the legacy MSC.

The initial location update procedure will fail due to failed authentication (wrong authentication key) in case the user has a TMSI from the CSFB MSC that was already allocated to a legacy user. The TMSI clash, however, will be resolved by a repeated location updating and TMSI reallocation procedure.

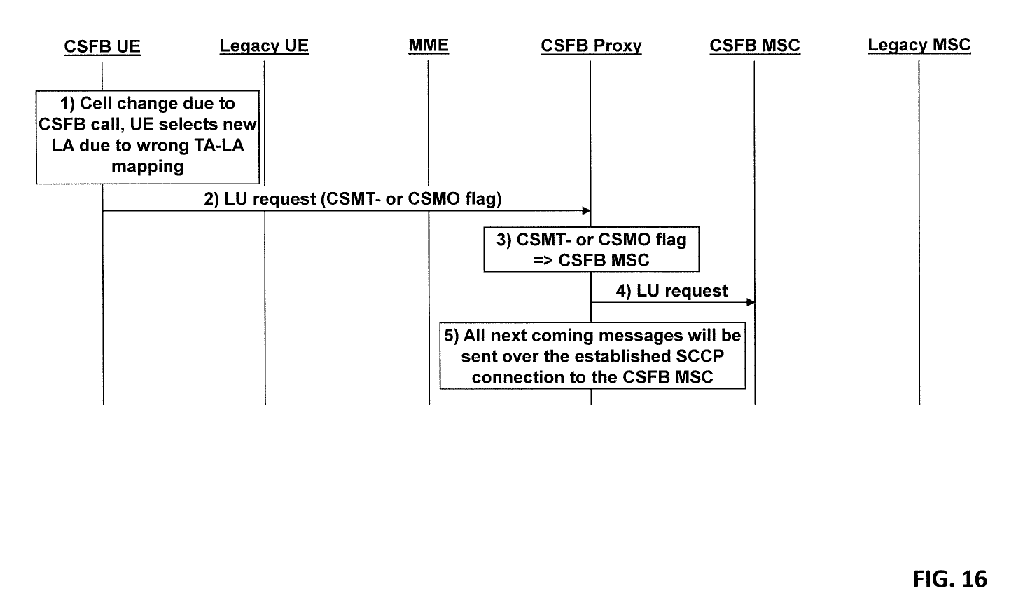

In connection with FIG. 16 the handling of location updates from CSFB users is shown when chaining the location area due to CSFB.

In step 1 of FIG. 16 a cell change due to a CSFB call occurs. The UE selects a new location area due to the wrong TA-LA mapping, TA being a “tracking area” which refers to a concept similar to LA “location area” but applies to LTE networks. In step 2 a location update request is sent to the CSFB proxy with the CSMT or CSMO flag being set. In step 3 the CSFB proxy analyzes the location update request from the CSFB user. As the location update is triggered by a CSFB call, either the CSMT or the CSMO flag is set and the message is routed to the CSFB MSC in step 4. As shown in step 5 all next coming messages will be sent over the established SCCP connection to the CSFB MSC.

### MOON Based Routing

3GPP Release 6 introduced the MOON concept (3GPP TS 23.251, Network Sharing) with which it is possible to connect several lu-interfaces to multiple MSC and SGSN nodes. In 3GPP Release 10 the MOON concept is also introduced for GSM.

The intention with the MOON standard is to separate subscribers that are roaming in a common RAN to different core networks belonging to different operators.

The invention here uses the MOON routing mechanisms for the purpose of avoiding and handling TMSI conflicts between a CSFB capable MSC and a legacy MSC when connected to a common CSFB Proxy.

Location update requests are routed to the CSFB MSC based on a specific TMSI-NRI which is valid only for the CSFB MSC. Location update requests with all other combinations of the TMSI are routed to the legacy MSC.

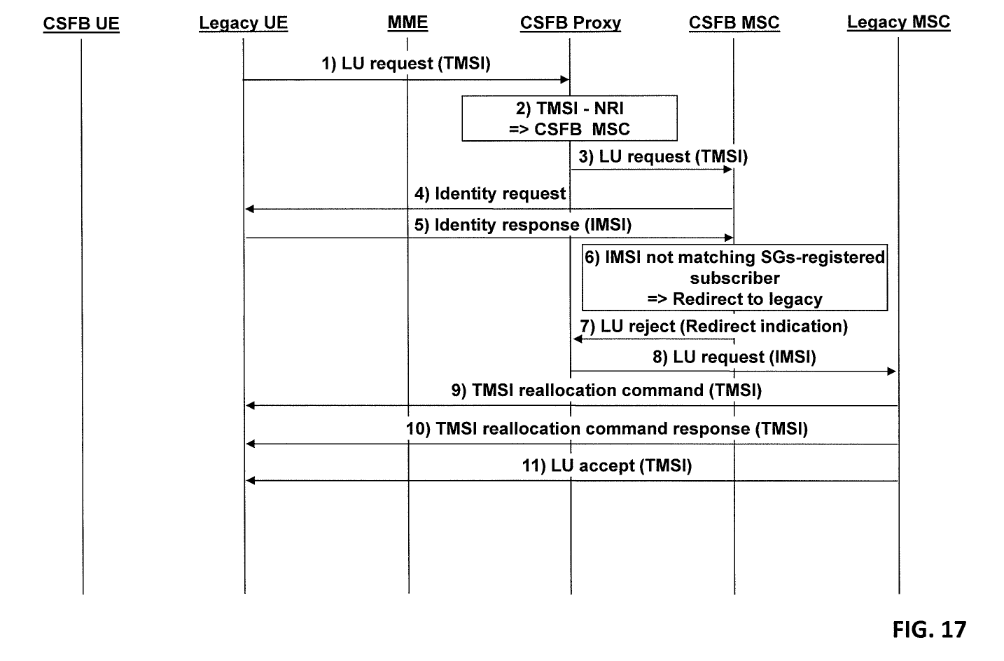

In case the legacy MSC accidentally allocates a TMSI for a subscriber which happens to have the bits for the NRI field matching the “TMSI-NRI” for the CSFB MSC, the consecutive location update request will wrongly be routed to the CSFB MSC (step 2 of FIG. 17). The CSFB MSC will when analyzing the IMSI of this subscriber detect that it is not registered over the SGs-interface (as for CSFB subscribers), and hence is not valid for roaming in the CSFB MSC (step 6). As a result, the CSFB MSC will redirect the subscriber to the CSFB Proxy which in its turn sends a new location update request to the legacy MSC. The CSFB MSC will remove the TMSI from the redirect message (location update reject with redirect indication) and the CSFB Proxy will then use IMSI in the new location update request to the legacy MSC.

The MOCN routing alternative is, as the CS MO/MT flag routing alternative, also using the association of originating signaling point codes (OPC) with paging requests and paging responses in order to assure that MT calls from the legacy MSC are always successful regardless if its TMSI occasionally happens to include bits that are matching the TMSI-NRI of the CSFB MSC. A paging request from the legacy MSC is stored with the IMSI or TMSI together with the OPC of the legacy MSC. When the paging response from the radio network arrives in the CSFB Proxy, it is routed to the legacy MSC if it can be associated with a stored paging request. If not, the paging response must be for a CSFB call (paging request sent over SGs-interface), and it will then instead be sent to the CSFB capable MSC.

The MOCN based routing is summarized in FIG. 17. In a first step the location update request is sent to the CSFB proxy, the update request containing a TMSI which happens to have the bits in the NRI field matching the TMSI-NRI for the CSFB MSC. In step 2 the proxy analyzes the TMSI-NRI and wrongly routes it to the CSFB MSC in step 3. The CSFB MSC transmits the identity request to the legacy UE and receives in step 5 an identity response with an IMSI included. The CSFB MSC then analyzes the IMSI and detects that it is not registered over the SGs interface as for the CSFB UE (step 6). As a consequence, the CSFB MSC will send a location update reject message to the proxy (step 7) which then in turn sends a new location update request to the legacy MSC (step 8). The legacy MSC will then send in step 9 a TMSI reallocation command including a TMSI to the legacy UE, the latter responding with a TMSI reallocation command response (step 10). In step 11 last but not least a location update accept message including the TMSI is sent to the legacy UE.

### LOG Based TMSI Routing

This solution is an improved version of the basic NRI approach. We will thus subdivide the TMSI range into two sub ranges; a reserved range which the proxy will route to the CSFB MSC and an unreserved range which the proxy will route to the legacy MSC.

Since we cannot control the TMSI assignments of the legacy MSC our focus is on the conflicts, i.e., cases when the legacy MSC assigns TMSIs from the reserved range. These conflicts can be subdivided into two cases, viz. single allocation conflicts and multiple allocation conflicts. When the legacy MSC has assigned a TMSI from the reserved range, a single allocation conflict occurs and CSFB MSC has noted that this TMSI is unused while a double allocation conflict occurs when the CSFB MSC has noted that this TMSI is assigned. MSCs will detect single allocation conflicts when the TMSI presented by a user is unknown, and double allocation conflicts when the authentication of a user fails.

To overcome the burstiness of TMSI conflicts mentioned above it is suggested to spread the TMSI of the CSFB MSC randomly over the entire (applicable) range and we propose a method for how to do this without complicating the routing decision for the proxy.

The idea is to convert incoming TMSIs t to transformed or converted TMSIs t′ upon which the routing decision is based. A simple transformation of the form

t′=(at+b)mod c (1)

can be used if the constants a, b and c are chosen properly. The transformation above is similar to the way in which pseudo random numbers may be computed according to the linear congruential method, e.g. J. Banks and J. Carson, Discrete-Event System Simulation, Prentice-Hall (1984) and A. Law and W. Kelton, Simulation Modeling & Analysis, McGraw-Hill (1991), for which there is a known set of rules for selecting a and b such that each value of t maps to exactly one value t′. (These rules are that b must be a relative prime of c (i.e., the only common factor in their factorisations into primes is one) and a −1 must be (i) divisible by all prime factors of c and (ii) a multiple of four if c is a multiple of four). Here are a few examples:

TABLE 1
Examples of suitable constants for transformation formula (1),

| a | b | c |
|---|---|---|
| 6364136223846793005 | 1442695040888963407 | 2³² |
| 1664525 | 1013904223 | 2³² |
| 69069 | 1 | 2³² |

The multiplication is simplified by expressing a as a power series of two, e.g.,

1664525=2²⁰+2¹⁹+2¹⁶+2¹⁴+2¹³+2¹⁰+2⁹+2³+2²+1

and, noting that multiplication by 2ⁿ is equivalent to n left shifts, adding 10 left shifted versions of t; one with 20 shifts, one with 19 shifts and so on until finally one with 0 shifts.

The modulus in all cases above is just a masking of all but the 32 least significant bits.

The transformed values can then be compared against specific ranges for new and legacy MSCs respectively. As a simple example, Table 2 shows the result when applying the first settings in Table 1.

TABLE 2
Transformations of the first ten original values (left) and “inverse
transformations” if the first ten transformed values (right).

| t | t′ | t′ | t |
|---|---|---|---|
| 0 | 4150755663 | 0 | 559108117 |
| 1 | 1140654204 | 1 | 1408334010 |
| 2 | 2425520041 | 2 | 2257559903 |
| 3 | 3710385878 | 3 | 3106785796 |
| 4 | 700284419 | 4 | 3956011689 |
| 5 | 1985150256 | 5 | 510270286 |
| 6 | 3270016093 | 6 | 1359496179 |
| 7 | 259914634 | 7 | 2208722072 |
| 8 | 1544780471 | 8 | 3057947965 |
| 9 | 2829646308 | 9 | 3907173858 |

To the left we see the result when an original TMSI t is mapped to a transformed TMSI' t′, and to the right we see the transformed TMSI' t′ and its corresponding original TMSI t. That is, original TMSI t=0 would be translated to transformed TMSI' t′=4150755663 and transformed TMSI' t′=0 is obtained from original TMSI t=559108117 etc. The two left columns show that assigning TMSI linearly in the original space t will appear random in the transformed space t′. Correspondingly, the two right columns show that a continuous range in transformed space t′ (e.g., 0-9) consists of a number of randomly scattered values in the original space t.

One idea is thus to define the reserved range in the transformed space rather than in the original space:
The legacy MSC will assign TMSIs t as before but the CSFB Proxy will see transformed TMSIs t′ that appear to be random. This is illustrated to the left in Table 2; when the legacy MSC assigns TMSI 0, 1, . . . , 9 from the t-space, the CSFB Proxy will see TMSI 4150755663, 1140645204, 2829646308 from the t′-space. Note how the TMSIs assigned by the legacy MSC seem to be scattered all over the TMSI range.
Similarly, the CSFB MSC will assign TMSIs t as before but it will prune the set the set of available TMSIs to match the allocated range TMSIs t′. This is illustrated to the right in Table 2; when the CSFB MSC has kept and assigns TMSI 51020286, 559108117, . . . , 3956011689 from the t-space, the CSFB Proxy will see TMSI 5, 0, . . . , 4 from the t′-space. Note how the TMSIs assigned by the CSFB MSC also seem to be scattered all over the TMSI range.

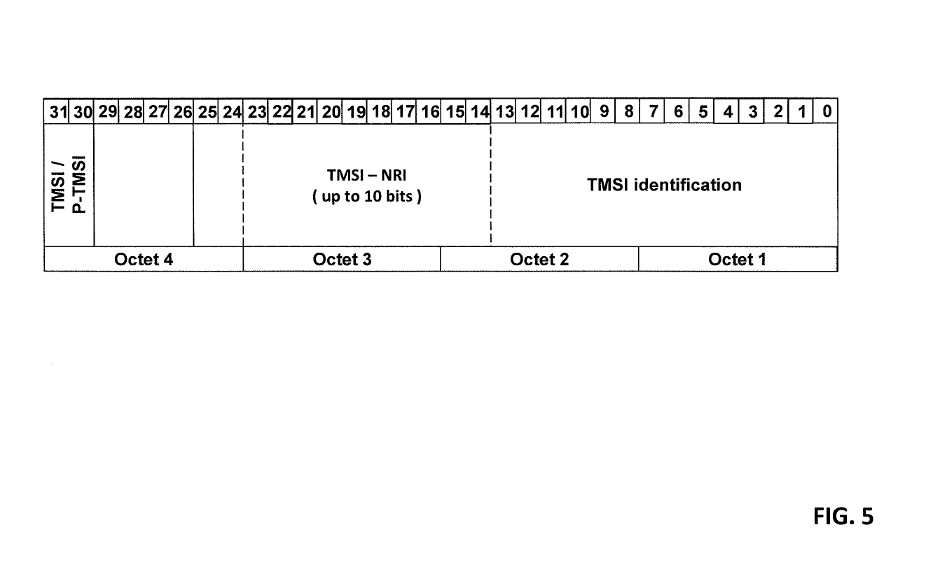

It is remarked that, as seen in FIG. 5, the entire TMSI range 0, . . . , 2³²−1 (0, . . . , 4294967295) is subdivided into a TMSI range (two first bits 00, 01 or 10) and a P-TMSI range (two first bits 11), and that, while all TMSI in the t-space belong to the TMSI range 0, . . . , ¾2⁼−1 (0, . . . , 3221225471), some TMSIs in the t′-space will belong to the P-TMSI range. Two remarks are in place:

Firstly, this is not a problem because transformed values are internal to the routing function of the CSFB Proxy; to see this, note that it just as well could keep a routing table for all (untransformed) TMSIs.

Secondly, the range of reserved values must be about ¼ larger than the number of TMSIs required but this will not impact the risk of conflicts; to see this, note that in the range 0-10 values 4 and 9 will not appear because they would be obtained from P-TMSI values which none of the MSCs will assign.

Summarizing, we see a TMSI is transformed into a converted TMSI by using a mechanism in which each TMSI is converted into exactly one TMSI' and in which consecutive numbers of the TMSI are transformed into randomly scattered TMSI', which are randomly scattered in the converted space.

Applying this method on the three nodes we thus have that
The CSFB MSC examines all TMSIs by running any of the above transformations (or any transformation with similar properties) on all TMSIs in its pool of TMSIs and discards all for which the result is greater than the number of reserved TMSIs, N. (Alternatively, it may read a table with the reserved TMSIs and/or apply some other transformation function including, e.g., modulus M.) This is thus done once when the system is restarted.
The proxy applies the same transformation on incoming TMSIs and bases its routing on the transformed result such that “transformed” TMSIs less than or equal to N are routed to the CSFB MSC whereas all other TMSIs are routed to the legacy MSC. (Alternatively, it may consult a table with the reserved TMSIs and/or apply some other transformation function including, e.g., modulus M.) This is thus done on every incoming request that must be routed.
The legacy MSC and the UEs are not impacted at all.

The advantages with this procedure may be described as follows:
1. Since the CSFB MSC will assign TMSIs which randomly scattered over the TMSI range there is no risk that the legacy TMSI will assign “undesired” TMSIs (i.e., TMSIs that map to the CSFB MSC) in bursts. This means that there is no risk of temporary load peaks due to “unfortunate” TMSI assignments.
2. The number of TMSIs that map to the CSFB MSC does not have to be set in multiples of two (as in the case where the values of specific bits point to the CSFB MSC) but it can be set to any value N and this will minimize the number of incorrect routing decisions and allows for flexible allocation of TMSIs.

As indicated above, the LCG should merely be seen as an example of a transformation function while another example is a simple modulus operation. There are many other examples of possible transformation functions, including other methods for random number generation and for computing hash numbers. With a table based approach any set of numbers can be used.

While the above proposal minimizes the risk of conflicts and eliminates the risk that these conflicts occur in bursts, there will still be conflicts. In more detail, the conflicts refer to UEs that where given “reserved” TMSIs by the legacy MSC but which thus are routed to the CSFB MSC.

As an example, consider a case where a CSFB MSC has 500,000 subscribers and a legacy MSC has 2,000,000 subscribers assume that the reserved range consist of 1,000,000 TMSI (twice the number of users). We then get the probability that the legacy MSC will select a TMSI from the reserved range as 10⁶/(¾ 2³²−2×10⁶)=3.106×10⁻⁴, i.e., one per 3,106 TMSI selections. (To see this, note that the numerator is the number of reserved TMSIs while the denominator is the number of TMSIs less the number of occupied TMSIs.)

In terms of the example in Table 2, a conflict will occur when, e.g., the legacy MSC assigns TMSI 5102070286 in the t-space because it corresponds to TMSI 5 in the t′-space. The conflict refers to a single allocation if the CSFB has TMSI 5102070286 in its idle list and to a double allocation if the CSFB has assigned TMSI 5102070286 to one of the CSFB users. Note how these conflicts will be evenly spread out over the entire range.

### Avoiding TMSI Conflicts

Although such conflicts can be detected and handled, a set of further proposals will remove these conflicts entirely. In the first variant we do this by repeating TMSI assignments that would have led to conflicts:
The CSFB proxy inspects all TMSI assignments from the legacy MSC and, if the TMSI belongs to the set of reserved TMSIs, replaces the TMSI by the null TMSI and the NB LAI. (The value Oxfffffffff, which will be interpreted as “no TMSI” by the UE).
The legacy MSC and UEs are not impacted at all.

The result is thus that we replace the assignment of a reserved TMSI by a second location update from the UE until an unreserved TMSI is assigned.

A second and rougher variant of the same proposal is to prevent TMSI assignments that would have led to conflicts:
The proxy inspects all TMSI assignments from the legacy MSC and, if the TMSI belongs to the set of reserved TMSIs, discards the messages.
The legacy MSC is not impacted at all.
The legacy MSC and UEs are not impacted at all.

The result is thus that we force the legacy MSC to do a new location update until an unreserved TMSI is assigned.

### Other TMSI-Based Solutions

### TMSI Translation

This solution uses two sets of TMSIs; one between the legacy MSC and the CSFB Proxy, and another one between the CSFB Proxy and the user. The legacy MSC may assign any TMSI while the CSFB Proxy only assigns TMSIs in the unreserved range. The CSFB Proxy also maintains a translation table with one entry per UE in the legacy MSC. The CSFB Proxy uses this table to swap TMSIs; the TMSI of the legacy MSC is replaced by the TMSI of the CSFB Proxy in southbound signals and vice versa in northbound signals.

From the point of view of translation, the legacy MSC may assign two kinds of TMSIs; unreserved ones and reserved ones. Unreserved TMSIs can remain intact and no actual translation is necessary. Reserved TMSIs should, however, be translated to avoid possible conflicts.

A complication with this approach is that inter MSC movements, say from a legacy MSC A to a legacy MSC B, the common procedure (where B uses the LAI to identify A, and A uses the TMSI to identify the user) will not work for translated TMSIs because MSCs use original TMSIs while the UEs use translated TMSIs.

This problem can be solved by letting CSFB Proxies translate TMSIs not only on the A-interface (UE to MSC) but also on the E-interface (MSC to MSC). This can be accomplished by, e.g., letting the CSFB Proxy act as signaling switching points (STPs) or by letting LAIs point to CSFB Proxies rather than (legacy) MSCs.

Noting that not all reserved TMSIs lead to conflicts, but only the ones which are in use when UEs change MSCs, another option is to accept these relatively few conflicts. It is also possible to minimize their impact by avoiding TMSIs which would lead to multiple allocation conflicts. To this end, the proxy may, e.g., assume that TMSIs which recently have been returned to the legacy MSC are the least likely ones to be assigned to other users for some time and therefore use these TMSIs for translation purposes.

### TMSI Taboo

This solution keeps track of all reserved TMSIs that currently are in use. The CSFB Proxy monitors signaling traffic, maintains a list of reserved TMSIs in use and uses this information to route traffic correctly. The CSFB MSC uses the same information to avoid second assignments of TMSIs by (i) not assigning those TMSIs if they are currently free and (ii) by changing those TMSIs if they already are assigned. Note that the last case requires that the assignment of the same TMSI by the legacy MSC must be delayed by the CSFB Proxy until the CSFB MSC has removed that TMSI. A further extension (or variant to (ii)) is to (iii) add sanctioned TMSIs such that the new MSC in its TMSI assignments favors (reserved) TMSIs that recently have become disused in the legacy MSC (since it may be expected that these TMSIs will not be assigned again in the near future).

Summing up, this option will not prevent all conflicts unless both (i) and (ii) are supported and the latter will at times require the CSFB Proxy to buffer TMSI assignments from the legacy MSC while the CSFB MSC performs a TMSI reassignment. In more detail, (i) prevents the CSFB MSC to assign something that the legacy MSC is using and option (ii) enables the legacy MSC to assign something the CSFB MSC is using. The frequency of such events may be reduced by implementing (iii) since it makes case (ii) less frequent.

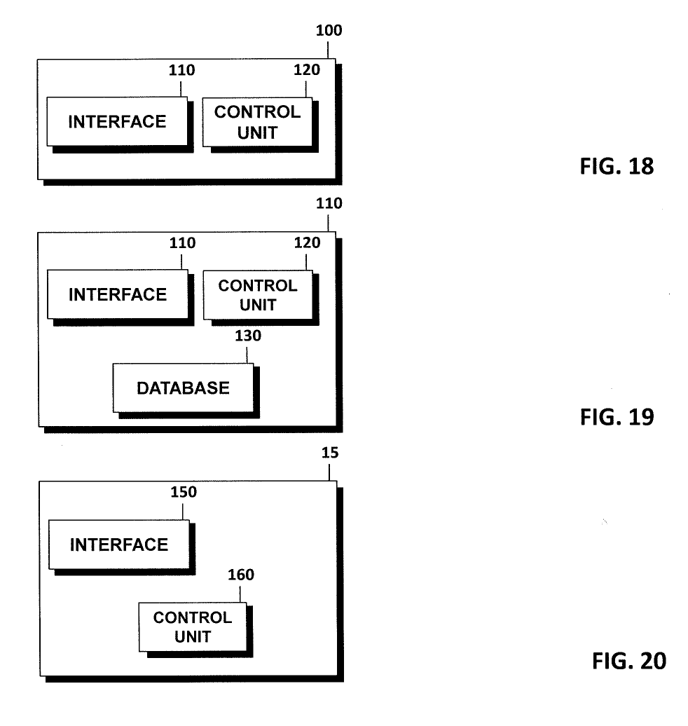

In FIG. 18 a schematic view of the circuit switched fallback proxy 100 is shown. As shown in FIGS. 6 and 7 the CSFB proxy 100 can be incorporated in a media gateway or in the BSC/RNC. It is connected over the A/lu-interface to the CSFB MSC and the legacy MSC. The proxy contains interface 110 where the different messages described above are received. The interface can be configured to process location to update messages, connection management request messages, paging response messages or general paging messages. Furthermore, the interface may receive routing of requests or location update reject messages. In the embodiment shown in FIG. 18 the interface 110 is shown as a single interface, however it should be understood that different interfaces may be used, the interface also depending on the used mobile communications network. By way of example, for GSM, if the proxy is located in the media gateway the interface may be the A-interface, whereas the Abis-interface may be used if the proxy is in the BSC. For WCDMA it should be the luCS-interface if the proxy is in the media gateway and on the lur-interface if the proxy is in an RNC. Furthermore, as schematically shown, the proxy furthermore contains a control unit 120 where the different decisions are taken and by which the proxy is controlled. By way of example, the control unit determines whether the CSMO or CSMT indicator is set and initiates a further routing to the correct MSC or the control unit searches for mobile subscriber identity information in a database not shown in order to determine whether a message is further routed to the CSFB MSC or to the legacy MSC. In connection with FIG. 19 a further embodiment of such a proxy is shown. In addition to the interface 110 and the control unit 120, already discussed in connection with FIG. 18, a database 130 is provided. By way of example, in this database the proxy can store mobile subscriber identity information and the corresponding originating point code. The control unit 120 can then, when a paging response is received, check in the database whether mobile subscriber identity information matching the mobile subscriber identity information contained in the paging response can be found. When no matching identity information is found, the control unit 120 initiates a routing of the packaging response to the CSFB MSC. It should be understood that the proxys shown in FIGS. 18 and 19 are configured to cover all of the embodiments described in connection with the invention.

In FIG. 20 a schematic view of a first switching control node 15 according to the invention is shown, this switching control node supports the CSFB functionality so it may be the CSFB MSC. An interface 150 is provided receiving a list of TMSIs used by the legacy MSC, wherein the control unit 160 generates inter alia TMSI for messages of a call controlled by the CSFB MSC 15. The control unit generates the TMSIs in such a way that TMSIs used by the legacy MSC are not assigned.

It such be noted that entities shown in FIGS. 18 to 20 can comprise additional functional entities and modules not shown. For the sake of clarity only the functional entities are shown which are necessary for the understanding of the present invention. Furthermore, the entities may be incorporated by hardware or software or by a combination of hardware and software.

### ADVANTAGES OF THE INVENTION

The CS Fallback Proxy solution enables the CS Fallback- and SMS over SGs features without having to upgrade the HW and SW in the existing legacy MSC network. Only minimum efforts are required for integrating the CS Fallback Proxy and the new CSFB capable MSC/MSS.

Further on, three additional values are especially important in comparison with overlaid CSFB GW/IWF solutions.
The CSFB Proxy requires no extra call setup time compared to an integrated CSFB/SGs solution. A CSFB GW/IWF solution requires some 5-10s additional call setup time.
The CSFB Proxy has no or insignificant capacity impact on the legacy network. A CSFB GW/IWF solution generates some 65% extra load per call on the legacy MSC layer and some 380% extra load per call on the HLR layer.
The CSFB Proxy requires no or insignificant extra signaling capacity on the legacy network. A CSFB GW/IWF requires some 5-8 times more signaling in the MSC-HLR interface per call.

1.-30. (canceled)

31. A proxy operative to handle messages of a mobile user equipment (UE) in a mobile communications network, the mobile communications network comprising a first switching control node supporting Circuit Switched Fallback (CSFB) functionality, and a second switching control node not supporting the CSFB functionality, the proxy comprising:
an interface configured to receive a message containing a Circuit Switched Fallback Mobile Originated (CSMO) call indicator or a Circuit Switched Fallback Mobile Terminated (CSMT) call indicator from the UE; and
a control unit configured to:
determine whether the CSMO call indicator or the CSMT call indicator is set in the received message;
initiate a routing of the received message to the first switching control node if either the CSMO call indicator or the CSMT call indicator is set; and
initiate a routing of the received message to the second switching control node if neither the CSMO call indicator nor the CSMT call indicator is set.

32. The proxy of claim 31, wherein the second switching control node is a Mobile Switching Center (MSC) supporting a Global System for Mobile Communication (GSM) or Wideband Code Division Multiple Access (WCDMA) mobile communications network.

33. The proxy of claim 31, wherein the message is a location update message, a connection management request message, or a paging response message.

34. A method implemented by a proxy for handling messages of a mobile user equipment (UE) in a mobile communications network, the mobile communications network comprising a first switching control node supporting Circuit Switched Fallback (CSFB) functionality and a second switching control node not supporting the CSFB functionality, the method comprising:
receiving a message containing a Circuit Switched Fallback Mobile Originated (CSMO) call indicator or a Circuit Switched Fallback Mobile Terminated (CSMT) call indicator from the UE;
determining whether the CSMO call indicator or the CSMT call indicator is set in the received message;
initiating routing of the received message to the first switching control node if either the CSMO call indicator or the CSMT call indicator is set; and
initiating routing of the received request message to the second switching control node if neither the CSMO call indicator nor the CSMT call indicator is set.

35. A proxy operative to handle paging messages for a mobile user equipment (UE) in a mobile communications network, the mobile communications network comprising a first switching control node supporting Circuit Switched Fallback (CSFB) functionality and a second switching control node not supporting the CSFB functionality, the proxy comprising:
an interface configured to receive a paging response from the UE;
a control unit configured to:
identify mobile subscriber identity information and originating signalling point information in the received paging response; and
initiate routing of the received paging response based on the identified information; and
a database containing, for different UEs, mobile subscriber identity information related to originating signalling point information;
wherein the control unit is further configured to:
search for mobile subscriber identity information in the database that matches the identified mobile subscriber identity information contained in the paging response;
initiate routing of the paging response to the second switching control node if matching mobile subscriber identity information is found in the database; and
initiate routing of the paging response to the first switching control node if no matching mobile subscriber identity information is found in the database.

36. The proxy of claim 35:
wherein the interface is further configured to receive a paging request for the mobile UE from the second switching control node; and
wherein the control unit is further configured to:
identify mobile subscriber identity information and a related originating signalling point information in the paging request; and
store the mobile subscriber identity information with its originating signalling point information from the paging request in the database.

37. A method implemented by a proxy for handling paging messages for a mobile user equipment (UE) in a mobile communications network, the mobile communications network comprising a first switching control node supporting Circuit Switched Fallback (CSFB) functionality and a second switching control node not supporting the Circuit Switched Fallback (CSFB) functionality, the method comprising:
receiving a paging response from the UE;
identifying mobile subscriber identity information and originating signalling point information in the paging response;
searching for mobile subscriber identity information in a proxy database containing, for different UEs, mobile subscriber identity information related to originating signalling point information, to determine a match for the mobile subscriber identity information contained in the received paging response;
routing the paging response to the second switching control node if a matching mobile subscriber identity information is found in the database; and
routing the paging response to the first switching control node if no matching mobile subscriber identity information is found in the database.

38. The method of claim 37, further comprising:
receiving a paging request for the UE from the second switching control node;
identifying additional mobile subscriber identity information and additional originating signalling point information in the paging request; and
storing the additional mobile subscriber identity information with the additional originating signalling point from the paging request in the database.

39. A proxy operative to handle routing of requests from a mobile user equipment (UE) in a mobile communications network, the mobile communications network comprising a first switching control node supporting Circuit Switched Fallback (CSFB) functionality and a second switching control node not supporting the CSFB functionality, comprising:
an interface configured to receive a location update request message from the UE including a Temporary Mobile Subscriber Identity Network Resource Identifier (TMSI-NRI) number;
a database containing a first range of TMSI-NRI numbers, and a second range of TMSI-NRI numbers that are different from the numbers in the first range; and
a control unit configured to:
identify the TMSI-NRI number included in the location update request message received from the UE;
initiate routing of the location update request message to the first switching control node if the identified TMSI-NRI number is in the first range; and
initiate routing of the location update request message to the second switching control node if the identified TMSI-NRI number is in the second range.

40. The proxy of claim 39:
wherein the interface is further configured to receive a location update reject message from the first switching control node; and
wherein the control unit is further configured to initiate routing of a new location update request message to the second switching control node based on the interface receiving the location update reject message from the first switching control node.

41. The proxy of claim 39:
wherein the interface is further configured to receive a paging request for the UE from the second switching control node; and
wherein the control unit is further configured to:
identify mobile subscriber identity information and originating signalling point information in the paging request; and
store the mobile subscriber identity information with the originating signalling point information from the paging request in the database.

42. The proxy of claim 41:
wherein the interface is configured to receive a paging response from the UE; and
wherein the control unit is further configured to:
identify received mobile subscriber identity information and received originating signalling point information in the received paging response;
search for mobile subscriber identity information in the database that matches the received mobile subscriber identity information contained in the paging response;
initiate routing of the paging response to the second switching control node if matching mobile subscriber identity information is found in the database; and
initiate routing of the paging response to the first switching control node if no matching mobile subscriber identity information is found in the database.

43. A method implemented by a proxy for handling routing of requests for a mobile user equipment (UE) in a mobile communications network, the mobile communications network comprising a first switching control node supporting Circuit Switched Fallback (CSFB) functionality and a second switching control node not supporting the CSFB functionality, the proxy containing a database containing a first range of Temporary Mobile Subscriber Identity Network Resource Identifier (TMSI-NRI) numbers, and a second range of TMSI-NRI numbers that are different from the numbers in the first range, the method comprising:
receiving a location update request message from the UE including a TMSI-NRI number;
identifying the TMSI-NRI number included in the location update request message;
routing the location update request message to the first switching control node if the identified TMSI-NRI number is in the first range; and
routing the location update request message to the second switching control node if the identified TMSI-NRI number is in the second range.

44. The method of claim 43, further comprising:
receiving a location update reject message from the first switching control node; and
routing a new location update request message to the second switching control node in response to the location update reject message being received.

45. The method of claim 43, further comprising:
receiving a paging request for the UE from the second switching control node;
identifying mobile subscriber identity information and originating signalling point information in the paging request; and
storing the mobile subscriber identity information with the originating signalling point from the paging request in the database.

46. The method of claim 45, further comprising:
receiving a paging response from the UE;
identifying received mobile subscriber identity information and received originating signalling point information in the paging response;
searching for mobile subscriber identity information in the database that matches the received mobile subscriber identity information contained in the paging response;
routing the paging response to the second switching control node if matching mobile subscriber identity information is found in the database; and
routing the paging response to the first switching control node if no matching mobile subscriber identity information is found in the database.

47. A proxy operative to route call-related messages for a mobile user equipment (UE) in a mobile communications network to one of a plurality of switching control nodes, the mobile communications network comprising a first switching control node supporting Circuit Switched Fallback (CSFB) functionality and a second switching control node not supporting the CSFB functionality, the proxy comprising:
an interface configured to receive a call-related message including a Temporary Mobile Subscriber Identity (TMSI) number;
a database storing a first range of converted TMSI numbers reserved for the first switching control node, and a second range of converted TMSI numbers that are different from the numbers in the first range, the converted TMSI numbers being stored in a converted space of the database; and
a control unit configured to:
identify the TMSI number in the call-related message;
convert the TMSI number of the call-related message into a converted TMSI number of a converted space such that the converted TMSI number is randomly distributed in the converted space;
route the call-related message to the first switching control node if the converted TMSI number is in the first range; and
route the call-related message to the second switching control node if the converted TMSI number is in the second range.

48. The proxy of claim 47:
wherein if the call-related message is received from the second switching control node;
wherein the control unit is further configured to replace the TMSI number in the call-related message with a predefined TMSI number if the converted TMSI number is in the first range reserved for the first switching control node.

49. The proxy of claim 47:
wherein if the call-related message is received from the second switching control node;
wherein the control unit is further configured to discard the call-related message if the converted TMSI number is in the first range reserved for the first switching control node.

50. The proxy of claim 47, wherein the control unit is configured to convert the TMSI number of the call-related message into a converted TMSI number using a formula by which each TMSI number is converted into exactly one value of a converted TMSI number.

51. The proxy of claim 47, wherein the control unit is configured to convert the TMSI number of the call-related message into a converted TMSI number using a formula by which consecutive numbers of the TMSI number are transformed into randomly scattered converted TMSI numbers.

52. A method for routing, by a proxy, call-related messages for a mobile user equipment (UE) in a mobile communications network to one of a plurality of switching control nodes, the mobile communications network comprising a first switching control node supporting Circuit Switched Fallback (CSFB) functionality and a second switching control node not supporting the CSFB functionality, the proxy containing a database containing a first range of converted Temporary Mobile Subscriber Identity (TMSI) numbers reserved for the first switching control node, and a second range of converted TMSI numbers different from the numbers in the first range, the method comprising:
receiving a call-related message including a TMSI number;
identifying the TMSI number in the call-related message;
converting the TMSI number into a converted TMSI number of a converted space in such a way that the converted TMSI number is randomly distributed in the converted space;
routing the call-related message to the first switching control node if the converted TMSI number is in the first range; and
routing the call-related message to the second switching control node if the converted TMSI number is in the second range.

53. The method of claim 52, further comprising:
receiving an additional call-related message from the second switching control node;
identifying the TMSI number contained in the additional call-related message; and
replacing the TMSI number in the additional call-related message with a predefined TMSI number if the TMSI number in the additional call-related message is in the first range reserved for the first switching control node.

54. The method of claim 52:
identifying a TMSI number contained in an additional call-related message received from the second switching control node; and
discarding the additional call-related message if the TMSI number in the additional call-related is in the first range reserved for the first switching control node.

55. A proxy operative to handle call-related messages for a mobile user equipment (UE) in a mobile communications network, the mobile communications network comprising a first switching control node supporting Circuit Switched Fallback (CSFB) functionality and a second switching control node not supporting the CSFB functionality, the proxy comprising:
a database containing:
a first set of Temporary Mobile Subscriber Identity (TMSI) numbers to be used for communication between the proxy and the second switching control node of the mobile communications network, wherein a predefined range of the TMSI numbers of the first set are in a reserved range of TMSI numbers that is reserved for the first switching control node;
a second set of TMSI numbers to be used for communication between the proxy and the UE; and
a translation table containing an entry for each of the UE whose calls are handled by the second switching control node, the translation table translating a TMSI number of the first set contained in the reserved range to a TMSI number of the second set, and vice versa;
an interface configured to receive a call-related message including a TMSI number from the second switching control node; and
a control unit configured to:
identify the TMSI number included in the call-related message transmitted from the second switching control node;
translate the identified TMSI number in the received message to a TMSI number of the second set based on the translation table, if the identified TMSI number in the call-related message from the second switching control node is in the reserved range of the first set; and
leave the identified TMSI number in the received message untranslated if the TMSI number is not in the reserved range.

56. The proxy of claim 55, wherein the control unit is further configured to translate the identified TMSI number to a TMSI number of the second set for TMSI numbers received on an A interface of the proxy or received on an E interface of the proxy.

57. A method implemented by a proxy for handling call-related messages for a mobile user equipment (UE) in a mobile communications network, the mobile communications network comprising a first switching control node supporting Circuit Switched Fallback (CSFB) functionality, and a second switching control node not supporting the CSFB functionality, the proxy comprising a database storing a first set and a second set of Temporary Mobile Subscriber Identity (TMSI) numbers, the method comprising:
receiving a call-related message including a TMSI number from the second switching control node; and
identifying the TMSI number included in the call-related message transmitted from the second switching control node;
translating the identified TMSI number to a TMSI number of the second set based on a translation table of the database, if the identified TMSI number in the call-related message from the second switching control node is in a reserved range of TMSI numbers of the first set of TMSI numbers; and
leaving the identified TMSI number untranslated if the identified TMSI number is not in the reserved range of the first set of TMSI numbers;
wherein the first set of TMSI numbers is used for a communication between the proxy and the second switching control node of the mobile communications network;
wherein the second set of TMSI numbers is used for a communication between the proxy and the UE;
wherein reserved range of TMSI numbers are reserved for the first switching control node; and
wherein the translation table contains an entry for each of UE whose calls are handled by the second switching control node, the translation table translating a TMSI number of the first set contained in the reserved range to a TMSI number of the second set, and vice versa.

58. A proxy operative to handle call-related messages for a mobile user equipment (UE) in a mobile communications network, the mobile communications network comprising a first switching control node supporting Circuit Switched Fallback (CSFB) functionality and a second switching control node not supporting the CSFB functionality, the proxy comprising:
a monitoring unit configured to:
monitor signalling of traffic of the mobile communications network; and
generate a list of Temporary Mobile Subscriber Identity (TMSI) numbers used by the second switching control node; and
an interface configured to inform the first switching control node of the generated list.

59. A first switching control node supporting Circuit Switched Fallback (CSFB) functionality for a mobile communications network, wherein the mobile communications network includes a second switching control node not supporting the CSFB functionality, the first switching control node comprising:
an interface configured to receive a list of Temporary Mobile Subscriber Identity (TMSI) numbers used by the second switching control node, the list being received from a proxy handling call-related messages; and
a control unit configured to:
generate TMSI numbers for messages of a call controlled by the first switching control node such that the control unit does not generate TMSI numbers contained in the received list; and
if given one of its generated TMSI numbers is determined to be in the list, to change that given TMSI number to a TMSI number that is not included in the list.

60. The first switching control node of claim 59, wherein the control unit is configured to assign TMSI numbers that have recently been released by the second switching control node.
